(19) United States
(12) Patent Application Publication
(10) Pub. No.: US 2009/0011297 A1
(43) Pub. Date: Jan. 8, 2009

(54) Metal composite electrode for a hydrogen generating apparatus

(75) Inventors: Jae-Hyuk Jang, Seongnam-si (KR); Arunabba Kundu, Suwon-si (KR); Jae-Hyoung Gil, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 12/216,417

(22) Filed: Jul. 3, 2008

(30) Foreign Application Priority Data
Jul. 3, 2007 (KR) 10-2007-0066498

(51) Int. Cl. H01M 8/18

(52) U.S. Cl. 429/19

(57) ABSTRACT

A metal composite electrode for a hydrogen generating apparatus and a hydrogen generating apparatus including the metal composite electrode are disclosed, where the metal composite electrode includes a metal and a metal hydride. The metal composite electrode used in a hydrogen generating apparatus can be utilized to increase the amount and duration of hydrogen generation.

### CROSS-REFERENCE TO RELATED APPLICATIONS

This application claims the benefit of Korean Patent Application No. 10-2007-0066498 filed with the Korean Intellectual Property Office on Jul. 3, 2007, the disclosure of which is incorporated herein by reference in its entirety.

### BACKGROUND

1. Technical Field

The present invention relates to a metal composite electrode for use in a hydrogen generating apparatus, and a hydrogen generating apparatus using the metal composite electrode.

2. Description of the Related Art

A fuel cell is an apparatus which converts the energies of pure hydrogen or hydrogen contained in hydrocarbon-based substances such as methanol and natural gases, and oxygen in the air, directly into electrical energy by way of an electrochemical reaction.

FIG. 1 illustrates the basic operational principle of a fuel cell.

Referring to FIG. 1, a fuel cell 10 may include a fuel electrode 11 as an anode and an air electrode 13 as a cathode. The fuel electrode 11 may receive molecular hydrogen (H₂), which can be dissociated into hydrogen ions (H⁺) and electrons (e⁻). The hydrogen ions may move past a membrane 12 towards the air electrode 13. This membrane 12 may correspond to an electrolyte layer. The electrons may move through an external circuit 14 to generate an electric current. The hydrogen ions and the electrons may combine with the oxygen in the air at the air electrode 13 to generate water. The fuel electrode 11 and the air electrode 13 may be disposed with the electrolyte membrane in-between, to form a membrane electrode assembly (MEA). The following Reaction Scheme 1 represents the chemical reactions in a fuel cell 10 described above:

### [Reaction Scheme 1]

Fuel electrode 11: H₂→H⁺+2e⁻

Air electrode 13: ½ O₂+2H⁺+2e⁻→H₂O

Overall reaction: H₂+½ O₂→H₂O

In short, the fuel cell 10 may function as an electrochemical cell, as the electrons dissociated from the fuel electrode 11 generate a current that passes through the external circuit. Such a fuel cell 10 can be a pollution-free power source, because it does not produce any noxious emissions such as SOₓ, NOₓ, etc., and produces only a little amount of carbon dioxide. The fuel cell may also offer several other advantages, such as low noise and little vibration, etc.

In order to obtain a high-performance fuel cell, hydrogen may be used as the fuel. In particular, a micro fuel cell (MFC) may advantageously be applied as a power source in portable electronic devices, such as cell phones and laptop computers, etc. A type of fuel cell suitable for a micro fuel cell is the polymer electrolyte membrane fuel cell (PEMFC), which operates at relatively low temperatures and has a high output density, and which is the subject of active development efforts. In commercializing the fuel cell, an important task to be resolved beforehand lies in the technology of storing and supplying hydrogen.

If the micro fuel cell uses a hydrogen storage material directly, which has a high hydrogen-volume/weight ratio, the efficiency of hydrogen generation becomes very low. Thus, there is a need for developments in materials and technology with regards using the hydrogen storage material. Besides this, there may also be a method of compressing hydrogen and supplying to the micro fuel cell, but there are as yet no suitable materials or technology that allows the storage of hydrogen after compression in a satisfactory manner.

To resolve the problems mentioned above, methods are being studied of installing a fuel processor at the front end of a micro fuel cell. The fuel processor can be an apparatus for reforming fuel, such as methanol and ethanol, etc., to generate hydrogen. However, fuel processor systems may entail high reform temperatures, complicated systems, and additional power consumption. Moreover, the reformed gas may likely contain impurities (e.g. CO₂, CO, etc.) of about 25% besides pure hydrogen.

Thus, the need is increasing for a hydrogen generating apparatus, which can resolve the problems in the method of generating hydrogen using the fuel processor and generate hydrogen efficiently.

### SUMMARY

An aspect of the invention is to provide a metal composite electrode for a hydrogen generating apparatus and a hydrogen generating apparatus including the metal composite electrode, with which pure hydrogen can be produced.

Another aspect of the invention is to provide a fuel cell system that utilizes the hydrogen generating apparatus.

One aspect of the invention provides a metal composite electrode for use in a hydrogen generating apparatus, where the metal composite electrode includes a metal and a metal hydride.

In certain embodiments of the invention, the metal can be magnesium or aluminum.

The metal hydride can be such that is selected from a group consisting of magnesium hydride, calcium hydride, lithium hydride, lithium borohydride, sodium borohydride, potassium borohydride, ammonium borohydride, tetramethyl ammonium borohydride, magnesium borohydride, calcium borohydride, sodium aluminum hydride, lithium aluminum hydride, potassium aluminum hydride, and mixtures thereof.

Another aspect of the invention provides a hydrogen generating apparatus that includes an electrolytic bath, which contains an electrolyte solution; a first metal composite electrode, which is positioned inside the electrolytic bath and immersed in the electrolyte solution, and which is configured to generate electrons; and a second metal electrode, which is positioned inside the electrolytic bath and immersed in the electrolyte solution, and which is configured to receive the electrons and generate hydrogen.

In certain embodiments of the invention, the hydrogen generating apparatus can further include a switch between the first metal composite electrode and the second metal electrode.

The hydrogen generating apparatus can be coupled to a fuel cell to supply hydrogen to the fuel cell, and can include multiple first metal composite electrodes and second metal electrodes installed inside the electrolyte bath.

Yet another aspect of the invention provides a fuel cell system that includes the hydrogen generating apparatus described above, and a membrane-electrode assembly (MEA) which receives the hydrogen generated by the hydrogen generating apparatus and converts the chemical energy of the hydrogen into electrical energy to produce a direct current.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates the basic operational principle of a typical fuel cell.

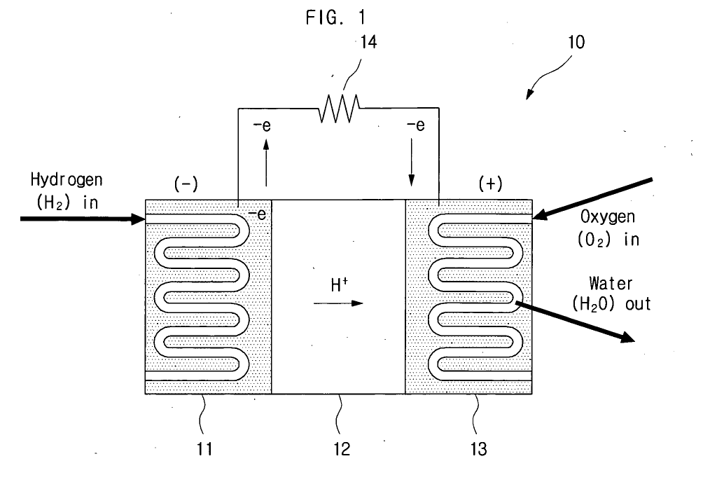

FIG. 2 is a schematic cross-sectional view of a hydrogen generating apparatus according to an embodiment of the present invention.

FIG. 3 is a schematic cross-sectional view of a hydrogen generating apparatus according to another embodiment of the present invention.

### DETAILED DESCRIPTION

Certain embodiments of the invention will be described below in more detail with reference to the accompanying drawings. Those components that are the same or are in correspondence are rendered the same reference numeral regardless of the figure number, and redundant explanations are omitted.

One method of generating hydrogen is to use metal electrodes. To be more specific, an aqueous electrolyte solution can be used, with a sacrificial anode made of magnesium or aluminum and a cathode made of stainless steel, etc., positioned inside the solution, where the water can be dissociated by electrolysis to produce hydrogen.

The sacrificial anode 23 can be an active electrode, where, due to the difference in ionization energy between the metal electrode (such as of magnesium, for example) and water (H₂O), the metal (Mg) electrode may release electrons (e⁻) into the water and become oxidized into magnesium ions (Mg²⁺). The electrons generated here may move through a cable 25 to the cathode 24.

The cathode 24 can be an inactive electrode. At the cathode 24, the water may receive the electrons that have traveled from the anode 23, to be dissociated into hydrogen.

The chemical reactions described above, using magnesium as an example of the material used for the anode, can be represented by the following Reaction Scheme 2:

[Reaction Scheme 2]

Anode: Mg→Mg²⁺+2e⁻

Cathode: 2H₂O+2e⁻→H₂+2(OH)⁻

Overall Reaction: Mg+2H₂O Mg(OH)₂+H₂

The method described above of electrolyzing water using metal electrodes may entail a low rate of water usage and hence a low efficiency in generating hydrogen. In a typical hydrogen generating system using metal electrodes as described above, the percentage of water used may be less than 20% of the total amount of water. Since, in such a system, one mole of hydrogen molecules can be produced per two moles of water, the efficiency of hydrogen generation may be low.

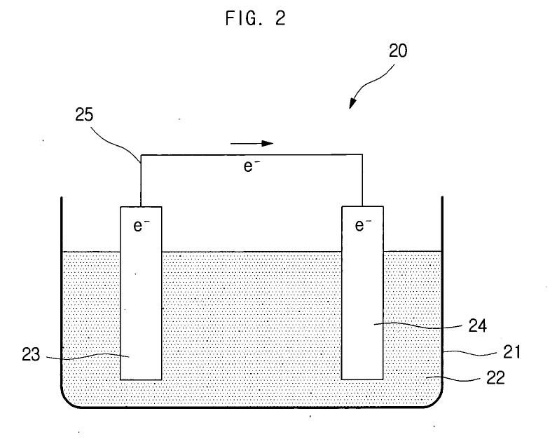

FIG. 2 is a schematic cross-sectional view of a hydrogen generating apparatus according to an embodiment of the present invention. The hydrogen generating apparatus 20 according to this embodiment can include an electrolytic bath 21, a first metal composite electrode 23, and a second metal electrode 24.

The electrolytic bath 21 can contain an electrolyte solution 22 inside. Also inside the electrolytic bath 21 can be a first metal composite electrode 23 and a second metal electrode 24. The first metal composite electrode 23 and the second metal electrode 24 may be immersed completely or partially in the electrolyte solution.

The first metal composite electrode can include a metal and a metal hydride.

The metal included in the first metal composite electrode can be magnesium or any of various other types of metal that has a relatively strong tendency to become ionized, such as aluminum (Al), zinc (Zn), and iron (Fe), etc. In certain examples, magnesium or aluminum may be desirable. Also, the second metal electrode 24 can be made of stainless steel or any of various other types of metal that has a relatively weaker tendency to be ionized compared to the metal forming the first metal composite electrode 23, such as platinum (Pt), copper (Cu), gold (Au), silver (Ag), and iron (Fe), etc.

The metal hydride included in the first metal composite electrode can be selected from a group consisting of magnesium hydride (MgH₂), calcium hydride (CaH₂), lithium hydride (LiH), lithium borohydride (LiBH₄), sodium borohydride (NaBH₄), potassium borohydride (KBH₄), ammonium borohydride (NH₄BH₄), tetramethyl ammonium borohydride ((CH₃)₄N(BH₄)), magnesium borohydride (Mg(BH₄)₂), calcium borohydride (Ca(BH₄)₂), sodium aluminum hydride (NaAlH₄), lithium aluminum hydride (LiAlH₄), potassium aluminum hydride (KAlH₄), and mixtures thereof.

The metal hydride may function as a reductant, and may react with water to produce hydrogen. This reaction, using magnesium hydride as an example, can be represented by the following Reaction Scheme 3:

[Reaction Scheme 3]

MgH₂+2H₂O→Mg(OH)₂+2H₂

This reaction, using sodium borohydride as another example, can be represented by the following Reaction Scheme 4:

[Reaction Scheme 4]

NaBH₄+2H₂O→NaBO₂+4H₂

The hydrogen generating apparatus according to an embodiment of the invention can be composed of the first metal composite electrode and the second metal electrode contained in the electrolyte solution and connected to each other. At the first metal composite electrode, in addition to the oxidizing reaction of magnesium, etc., the metal hydride may serve as a reductant to produce hydrogen. As such, the hydrogen generating apparatus according to an embodiment of the invention can generate hydrogen using both electrolysis of the water and chemical hydrolysis of the metal hydride. The rate of this chemical hydrolysis of the metal hydride may increase in proportion to the rate of the electrolysis of water, the progression of which expends the metal (e.g. magnesium, aluminum, etc.). Thus, a metal composite electrode for a hydrogen generating apparatus according to an embodiment of the invention can be utilized to increase hydrogen production.

Also, when a metal composite electrode made of a metal and a metal hydride is used in accordance to this embodiment, the amount of water consumed for producing one mole of hydrogen molecules can be reduced, whereby the rate of water usage can be increased. Therefore, using the metal composite electrode according to an embodiment of the invention can increase the total energy density of the hydrogen generating reaction system.

A composite electrode according to an embodiment of the invention can be made of a metal and a metal hydride to increase hydrogen production. Here, the metal hydride can be a nonconductor. In order for the metal hydride to react to the electrolysis of water in the hydrogen generating apparatus, it can be advantageous to render a conductive quality to the metal hydride. This may be achieved by various methods, three of which are described below as examples.

First, a mixture containing a metal hydride powder and a conductive polymer paste can be coated over a thin metal plate, to provide a conductive quality to the non-conductive metal hydride.

That is, the conductive polymer paste can render a conductive quality to the non-conductive metal hydride, so that a composite electrode manufactured by mixing a metal, a metal hydride, and a conductive polymer paste can be made conductive.

Second, a metal powder and a metal hydride powder can be mixed together, after which hot pressing can be applied to manufacture a composite electrode that is conductive.

Third, a metal hydride can be formed over a metal surface, a portion of the metal surface can be exposed, and then a metal can be deposited over the metal hydride by sputtering. By thus depositing a metal by sputtering, the metal hydride can be given a conductive quality.

The electrolyte solution can further include inorganic salts, in order to increase conductivity. The inorganic salts can be used to partially or completely dissolve reaction by-products, such as metal hydroxides and borate salts, which may be generated as the reaction progresses at the metal composite electrode of an embodiment of the invention. Since the inorganic salts can facilitate the hydrolysis of the (boro)hydride, the induction time for hydrogen generation can also be reduced.

Examples of inorganic salts that can be used in embodiments of the invention include, but are not limited to, lithium chloride, potassium chloride, sodium chloride, calcium chloride, potassium nitrate, sodium nitrate, potassium sulfate, sodium sulfate, and mixtures thereof.

Another aspect of the invention can provide a hydrogen generating apparatus that includes the metal composite electrode described above, which may be made of a metal and a metal hydride.

To be more specific, a hydrogen generating apparatus can be provided that includes an electrolyte bath, which contains an electrolyte solution; a first metal composite electrode, which is made of a metal and a metal hydride, positioned inside the electrolytic bath, and immersed in the electrolyte solution, for generating electrons; and a second metal electrode, which is positioned inside the electrolytic bath and immersed in the electrolyte solution, and which serves as a cathode for receiving the electrons and generating hydrogen.

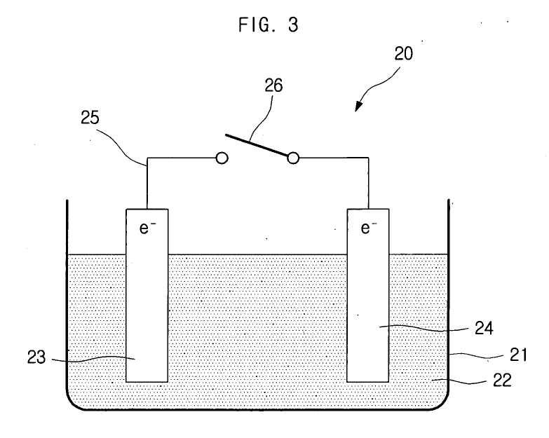

As shown in FIG. 3, the hydrogen generating apparatus may further include a switch 26 positioned between the first metal composite electrode 23 and the second electrode 24. If the switch is turned on, the electrons generated at the first electrode 23 can be moved to the second electrode 24, and if it is turned off, the electrons generated at the first electrode 23 can be made not to move to the second electrode 24. In the case of a hydrogen generating apparatus based on an embodiment of the invention, the induction time for hydrogen generation can be shortened and the amount of hydrogen generated can be increased, so that a very quick response time may be obtained for the on/off switch.

In certain embodiments of the invention, multiple first metal composite electrodes 23 and/or multiple second metal electrodes 24 may be installed in the electrolytic bath 21. Increasing the number of first metal composite electrodes 23 and/or second metal electrodes 24 can increase the quantity of hydrogen generated for the same duration, making it possible to generate a desired quantity of hydrogen ink a shorter period of time.

In addition, a hydrogen generating apparatus according to an embodiment of the invention may be coupled to a fuel cell to supply hydrogen to the fuel cell. The fuel cell may be, but is not limited to, a polymer electrolyte membrane fuel cell (PEMFC), which can be more suited for use in a micro fuel cell.

A high-efficiency hydrogen generating apparatus based on certain embodiments of the invention may also be used in a fuel cell system that includes a membrane-electrode assembly (MEA), to which hydrogen is supplied and which coverts the chemical energy of the hydrogen to electrical energy and thus produce a direct current.

To be more specific, the hydrogen discharged from the hydrogen generating apparatus can be supplied to the anode of the fuel cell, while air can be supplied to the cathode of the fuel cell, to generate an electric current in the MEA between the anode and cathode. The electric current thus generated can be collected by current collectors, so that the fuel cell may provide electrical power. The electrical power from the fuel cell can be supplied to a portable electronic device as a power source.

Here, the hydrogen generating apparatus that includes a composite electrode of metal and metal hydride can be made to allow convenient coupling to and separating from the fuel cell. For example, the hydrogen generating apparatus and the anode of the fuel cell can be connected using a one-touch type tube.

Thus, the hydrogen generating apparatus including a composite electrode of metal and metal hydride and a fuel cell can be coupled and installed in a portable electronic device.

Also, as the hydrogen generating apparatus and the fuel cell can be coupled and separated using a one-touch tube, the hydrogen generating apparatus and the fuel cell can be connected by a fuel pipe for use in the portable electronic device.

Since the hydrogen generating apparatus and the fuel cell can be coupled and separated using a one-touch tube, the fuel cell can be kept permanently within the electronic device, with only the hydrogen generating apparatus separated and replaced when necessary.

The invention may be better understood by referring to the following examples which are intended for illustrative purposes only and are not to be construed in any way as limiting the scope of the present invention, which is defined in the claims appended hereto.

### EXAMPLE 1

MgH₂ powder (particle size 0.1 mm and lower), Mg powder (particle size 0.1 mm and lower), and a conductive polymer paste may be mixed in suitable proportions (MgH₂: Mg: conductive polymer=0.1% or greater: 0.1% or greater: remaining volume %). The semisolid mixture of MgH₂ powder, Mg powder, and conductive polymer paste may be thinly coated (e.g. to a thickness of 0.3 mm) over a thin metal plate of Mg (e.g. thickness of 0.1 mm, dimensions 50 cm by 36 cm). Another thin metal plate of Mg (e.g. 0.1 mm thickness) may be attached to the mixture, and a plastic clip may be used to secure the thin plates. To provide effective hydrogen generation in the semisolid substance between the Mg thin plates, holes may be punched in suitable intervals (e.g. 5 mm in the lateral and longitudinal directions) through which water may flow.

### EXAMPLE 2

A thin metal plate of a 0.5 mm thickness may be cut into a suitable size (e.g. 50 cm by 36 cm by 0.5 mm). To fill in a MgH₂ and Mg powder mixture in a larger quantity, a mold may be fabricated that has metal rods (e.g. 2 mm diameter, 5 mm height) protruding in suitable intervals (e.g. 1 mm) for injecting the powder at a suitable depth (e.g. 0.3 mm). The MgH₂ and Mg powder mixture may be fed through a sieve that allows the powder to pass through holes corresponding to the positions of the metal rods protruding from the mold. The powder may further be added if necessary, after using the metal rod mold. Another thin metal plate of Mg may be placed on top, and the configuration may be hot pressed at a temperature of 100 to 140° C. to produce hydrogen electrodes (Mg-MgH₂ & Mg-Mg).

### EXAMPLE 3

A thin metal plate of Mg may be prepared to a suitable size (e.g. 50 cm by 36 cm by 0.5 mm) and may be cleansed of impurities using isopropanol alcohol (IPA). A thermally resistant polyimide tape may be attached to both sides of the Mg thin metal plate in suitable intervals (e.g. 2 mm by 2 mm). A MgH₂ slip may be prepared beforehand. The method of preparing the slip may be as follows. A mixture including 30 to 45 wt % of a mold additive PVB, 30 wt % of alcohol, and MgH₂, of a concentration suitable for doctor blading, e.g. 3 cps, may be dried at 100° C. for 10 minutes. A doctor blading procedure may be applied using this slip, over the thin metal plate having attached tape that is prepared as described above, to a thickness of 0.1 mm. For a secure adhesion of the slip, the configuration may be dried with hot air of about 100 to 110° C. for 20 to 30 minutes. The same process may be performed for the reverse side. The tape may then be peeled off to expose the surfaces of the Mg plates. Mg may be deposited on both sides by sputtering, to a thickness of 1 to 20 μm.

Using the metal composite electrodes above, a hydrogen generating apparatus was constructed that provides a hydrogen generation rate of 40 cc/min. Measurements obtained using a mass flow meter (MFM) showed increases in both the amount of hydrogen generation and the duration of hydrogen generation.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A metal composite electrode for use in a hydrogen generating apparatus, the metal composite electrode comprising a metal and a metal hydride.

2. The metal composite electrode of claim 1, wherein the metal is magnesium or aluminum.

3. The metal composite electrode of claim 1, wherein the metal hydride is selected from a group consisting of magnesium hydride, calcium hydride, lithium hydride, lithium borohydride, sodium borohydride, potassium borohydride, ammonium borohydride, tetramethyl ammonium borohydride, magnesium borohydride, calcium borohydride, sodium aluminum hydride, lithium aluminum hydride, potassium aluminum hydride, and mixtures thereof.

4. A hydrogen generating apparatus comprising:
an electrolytic bath containing an electrolyte solution;
a first metal composite electrode positioned inside the electrolytic bath and immersed in the electrolyte solution, the first metal composite electrode configured to generate electrons; and
a second metal electrode positioned inside the electrolytic bath and immersed in the electrolyte solution, the second metal electrode configured to receive the electrons and generate hydrogen.

5. The hydrogen generating apparatus of claim 4, wherein the metal is magnesium or aluminum.

6. The hydrogen generating apparatus of claim 4, wherein the metal hydride is selected from a group consisting of magnesium hydride, calcium hydride, lithium hydride, lithium borohydride, sodium borohydride, potassium borohydride, ammonium borohydride, tetramethyl ammonium borohydride, magnesium borohydride, calcium borohydride, sodium aluminum hydride, lithium aluminum hydride, potassium aluminum hydride, and mixtures thereof.

7. The hydrogen generating apparatus of claim 4, further comprising a switch positioned between the first metal composite electrode and the second metal electrode.

8. The hydrogen generating apparatus of claim 4, wherein the hydrogen generating apparatus is coupled to a fuel cell and configured to supply hydrogen to the fuel cell.

9. The hydrogen generating apparatus of claim 4, comprising a plurality of first metal composite electrodes and a plurality of second metal electrodes installed inside the electrolyte bath.

10. A fuel cell system comprising:
a hydrogen generating apparatus; and
a membrane electrode assembly (MEA) configured to receive hydrogen generated by the hydrogen generating apparatus and convert chemical energy of the hydrogen into electrical energy to produce a direct current,
wherein the hydrogen generating apparatus comprises:
an electrolytic bath containing an electrolyte solution;
a first metal composite electrode positioned inside the electrolytic bath and immersed in the electrolyte solution, the first metal composite electrode configured to generate electrons; and
a second metal electrode positioned inside the electrolytic bath and immersed in the electrolyte solution, the second metal electrode configured to receive the electrons and generate hydrogen.

11. The fuel cell system of claim 10, wherein the metal is magnesium or aluminum.

12. The fuel cell system of claim 10, wherein the metal hydride is selected from a group consisting of magnesium hydride, calcium hydride, lithium hydride, lithium borohydride, sodium borohydride, potassium borohydride, ammonium borohydride, tetramethyl ammonium borohydride, magnesium borohydride, calcium borohydride, sodium aluminum hydride, lithium aluminum hydride, potassium aluminum hydride, and mixtures thereof.

13. The fuel cell system of claim 10, further comprising a switch positioned between the first metal composite electrode and the second metal electrode.

14. The fuel cell system of claim 10, wherein the hydrogen generating apparatus is coupled to a fuel cell and configured to supply hydrogen to the fuel cell.

15. The fuel cell system of claim 10, wherein the hydrogen generating apparatus comprises a plurality of first metal composite electrodes and a plurality of second metal electrodes installed inside the electrolyte bath.
